(19) United States
(12) Patent Application Publication
(10) Pub. No.: US 2015/0248248 A1
(43) Pub. Date: Sep. 3, 2015

(54) WRITING STANDARD TAPE FORMAT TO MEMORY

(71) Applicant: HEWLETT-PACKARD DEVELOPMENT COMPANY, L.P., Houston, TX (US)

(72) Inventors: Gregory Trezise, Bristol (GB); Andrew Hana, Bristol (GB)

(21) Appl. No.: 14/427,073

(22) PCT Filed: Oct. 31, 2012
(86) PCT No.: PCT/US2012/062810

§ 371 Date: Mar. 10, 2015

(51) Int. Cl. G06F 3/06; G11B 20/12; G06F 12/02

(52) U.S. Cl. CPC G06F 3/0619; G06F 12/0246; G11B 20/1201; G06F 3/065; G06F 3/0685; G06F 2212/1032; G06F 2212/165; G06F 2212/2022; G06F 2212/213; G06F 2212/214; G06F 2212/251; G06F 2212/261; G06F 2212/70; G06F 2212/72; G06F 2003/0698; G06F 2003/0695

(57) ABSTRACT

The present disclosure provides techniques for writing data in standard tape format to solid state, non-volatile storage medium. A cartridge disposed within a non-volatile memory storage (NVM) drive may contain an inexpensive, solid state, non-volatile storage medium rather than magnetic tape. The NVM drive may write data to the solid state, non-volatile storage medium. Improved cost savings may thus be seen.

### BACKGROUND

Linear tape drives are widely used for computer backup and archiving. A linear tape drive typically includes a magnetic tape head that reads and writes magnetic tape linearly, such that data on the magnetic tape is read and/or written in sequence along the length of the magnetic tape. Multiple channels of data may be written to, and read from, the magnetic tape in parallel using multiple elements on the magnetic tape head. To avoid losing data due to bit errors, data can be stored redundantly and various error correcting algorithms can be applied to the data writing and reading processes.

### BRIEF DESCRIPTION OF THE DRAWINGS

Certain exemplary embodiments are described in the following detailed description and in reference to the drawings, in which:

FIG. 1 is a schematic of a computer network environment that may be used;

FIG. 2 is a block diagram of a cartridge in contact with a non-volatile memory storage drive;

FIG. 3 is a process flow diagram showing an example of a method for writing data to a solid-state, non-volatile memory;

FIG. 4 is a process flow diagram showing an example of a method for data recovery; and

FIG. 5 is a process flow diagram showing a method for writing standard tape format to solid-state, non-volatile memory.

### DETAILED DESCRIPTION OF SPECIFIC EMBODIMENTS

Embodiments disclosed herein provide techniques for writing standard tape-formatted data to solid-state, non-volatile memory, such as NAND-flash, NOR-Flash and other types of flash memory. Magnetic tape has long been used for computer backup and archiving. During the reading or writing of magnetic tape, various errors, such as bit errors, may tend to occur. For example, bit errors may take the form of random (single bit) errors, burst (multi-bit) errors due to media defects, or catastrophic failures with relatively long duration caused by a head “clog” or failure to follow the written track accurately when reading or writing. Other types of failures may also occur. To improve reliability, tape formats incorporate a high level of redundancy to the original data. Embodiments of the present techniques provide for a back-up storage medium that uses solid-state, non-volatile memory instead of magnetic tape. The storage medium may be disposed in a cartridge that is configured to be compatible with a non-volatile memory (NVM) storage drive. In an example, the NVM storage drive may be essentially a standard tape drive configured to write to a solid-state, non-volatile (SSNV) memory rather than magnetic tape. In embodiments, the data formatting applied by the NVM drive to data stored on the SSNV memory will be essentially the same as if the data was stored to a cartridge with magnetic tape by a tape drive, with minor modifications to simplify the format. For example, SERVO bands used when writing to magnetic tape are not necessary when writing to SSNV memory. In an example, the data that would normally be written to the magnetic tape can be stored serially in successive memory addresses of the solid-state, non-volatile memory. The high level of redundancy and error correcting mechanisms used by the data format applied by the NVM drive provides protection against errors. In this way, inexpensive solid-state non-volatile memory, which would typically be considered to be of too low quality for use as a backup medium, may be used in place of magnetic tape.

The advantages of using inexpensive solid-state non-volatile memory include significant cost savings, both because the SSNV memory is less expensive than magnetic tape or high-end non-volatile memory, and because tape formatted data may be written to the memory in a linear fashion, resulting in less wear and tear and a corresponding lower degradation rate of the memory. The term “linear” refers to writing data to successes addresses of a SSNV memory. Because of the benign nature of the memory use, degradation rates do not have to be managed. In addition, the robustness of cartridges which include SSNV memory in place of magnetic tape may be improved. Cost savings can therefore be seen in the cartridges and the NVM drive itself. Further advantages include improved media reliability and improved transfer rates to and from the media.

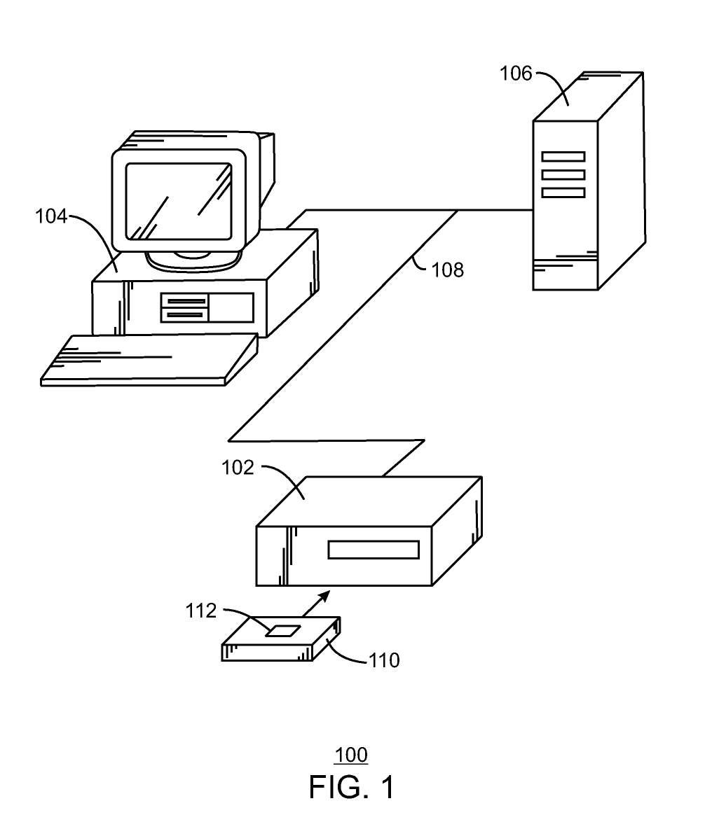

FIG. 1 is a diagram of a computer network environment 100 that may be used to write data to a solid-state, non-volatile memory backup cartridge via a NVM drive. The computer network environment 100 may include a NVM drive 102 that is communicably coupled to a computer 104 or a network server 106, or both, via a wired connection 108. However, in various examples, the NVM drive 102 is communicably coupled to the computer 104 or the network server 106, or both, via a wireless connection, such as a wide area network (WAN), local area network (LAN), or the Internet.

The computer 104 or the network server 106 may be configured to read data from and write data to the NVM drive 102. The computer 104 and the network server 106, together or individually, may form a host computing system for the NVM drive 102. In various examples, the NVM drive 102 is a data storage and retrieval device that is configured in the form of a stand-alone computer storage drive. In other examples, the NVM drive 102 is disposed within the computer 104 or the network server 106. For example, the NVM drive 102 may be supported in a bay inside a housing of the computer 104 or the network server 106. In another example, the NVM drive 102 may be included in a library including multiple NVM drives with automated pickers to auto-load cartridges into the NVM drives.

As shown in FIG. 1, the NVM drive 102 is configured to use cartridges such as cartridge 110. The cartridge 110 may include a non-volatile memory 112 other than magnetic tape. The non-volatile memory 112 may be any type of solid-state, non-volatile memory. Furthermore, the non-volatile memory 112 may also be random access memory as opposed to sequential access memory wherein data is read and written in a predetermined order, such as a hard disk, magnetic tape, optical disk, and the like. For example, the memory 112 may include flash memory, ferroelectric RAM, and memristor memory, among others. In an example, the cartridge 110 may include a single non-volatile memory. In another example, the cartridge 110 may include multiple non-volatile memories, as explained further below.

It is to be understood that the computer network environment 100 may include any number of additional components not shown in FIG. 1. In addition, any number of the components shown in FIG. 1 may not be included within the computer network environment 100, depending on the specific application.

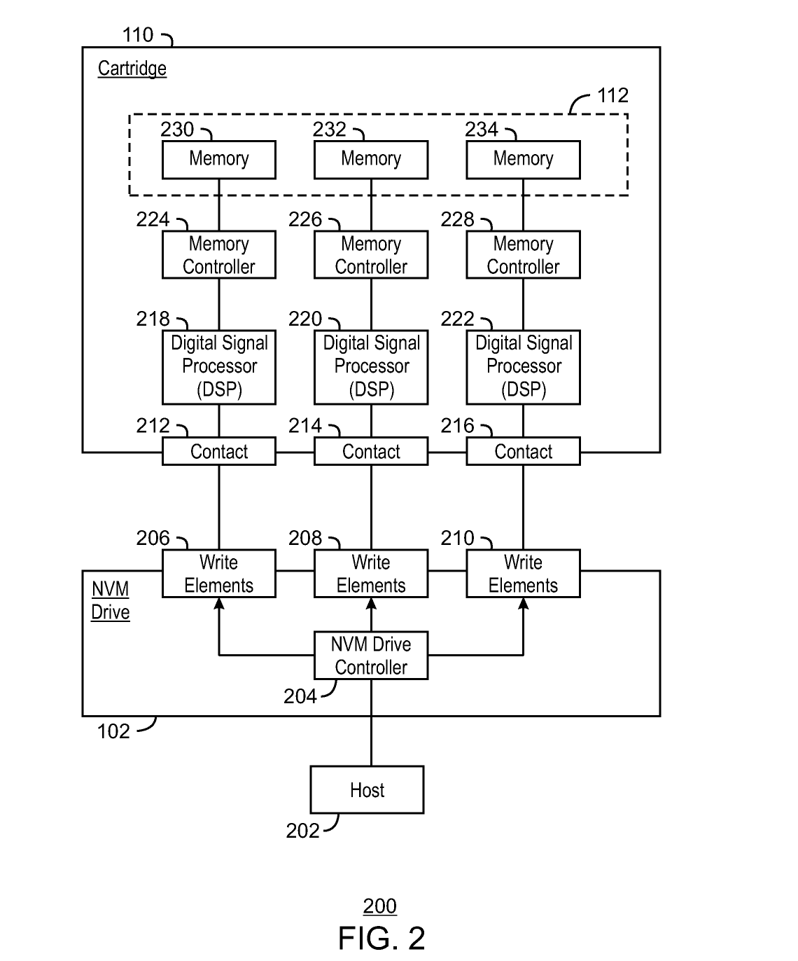

FIG. 2 is a block diagram of a NVM drive and a back-up cartridge with a solid-state, non-volatile memory. Like numbered items are as described with respect to FIG. 1.

As shown in FIG. 2, the NVM drive may be connected to a host 202. The host may be host computer 104, host network 106, or a combination of host computer 104 and host network 106. The NVM drive 102 may include a NVM drive controller 204. The NVM drive controller 204 may include computer-readable instructions, implemented in firmware for example, that are configured to direct the functioning of the hardware within the NVM drive 102. In examples, the NVM drive controller 204 may be configured to monitor various parameters of the NVM drive 102 while the NVM drive is attempting to access the non-volatile memory 112. As used herein the term parameter refers to any suitable characterization of the operating conditions of the NVM drive. Furthermore, the term access is used herein to refer to any type of data access, including data write operations and data read operations. In another example, the NVM drive controller 204 may be configured to perform house-keeping operations, such as reading drive-use logs or cartridge-use logs.

Additionally, the NVM drive controller 204 may select the interleaved data read elements. In various examples, the NVM drive 102 includes a number of data read elements (not shown) and data write elements 206, 208, and 210 that are configured to read data from or write data to the non-volatile memory 112, respectively. In an example, the NVM drive 102 may include dual-use read-write elements that may be used for both reading and writing. The read and write elements may be Input/Output (I/O) signal pads which communicate with I/O pins on the non-volatile memory. In addition, the write elements may be configured to write format information to the non-volatile memory 112. The format information may include an appropriate data transfer rate to be used to read data from the non-volatile memory during future read and write operations. In an example, the NVM drive 102 may include one or more write arrays and one or more read arrays. The write array may include any number of data write elements 206, 208, and 210, or channels, for writing data to the non-volatile memory 112. In an example, the write array may include sixteen data write elements within the write array. In another example, the write array includes thirty-two data write elements.

As shown in FIG. 2, the cartridge 110 may include at least one electrical contact, such as contact 212. In an example, the cartridge 110 may include a single electrical contact 212. In another example, the cartridge 110 may include multiple electrical contacts, such as electrical contacts 212, 214, and 216. By contacting the electrical contacts, write elements 206, 208, and 210 may transfer data to the non-volatile memory 112 disposed within the cartridge 110. In a further example, the NVM drive 102 may communicate wirelessly with the cartridge 110, such as with Wi-Fi or wireless USB.

Each electrical contact may be connected to a Digital Signal Processor (DSP). For example, electrical contact 212 may be connected to Digital Signal Processor (DSP) 218. DSP 218 may further be connected through memory controller 224 to memory 230. The remaining contacts may similarly be connected to the remaining memories. For example, contacts 212 and 214 may similarly be connected to memory 232 and memory 234, respectively.

As further shown in FIG. 2, the cartridge 110 may include a solid-state, non-volatile memory 112 disposed within the cartridge 110, rather than a magnetic tape. In an example, the cartridge 110 may include a single non-volatile memory 112. In another example, the data cartridge 110 may include multiple non-volatile memories, such as memories 230, 232, and 234. For example, the number of non-volatile memories included within a cartridge may directly correspond to the number of write elements or channels in the NVM drive 102.

Each data write element 206, 208, and 210 may be associated with a particular non-volatile memory 230, 232, and 234. As such, multiple non-volatile memories may be disposed within the NVM drive 102, such as within a cartridge 110 inserted in the NVM drive 102. Because each data write element is associated with its own particular non-volatile memory, multiple non-volatile memories may be written to in parallel, allowing for increased data transfer rates. For example, in an array including sixteen data write elements, sixteen data write elements may write data to sixteen non-volatile memories at the same time, by writing to the memories in parallel.

The NVM drive 102 may be configured to write data to the non-volatile memory 112 linearly. Linearly means that data on the non-volatile memory is read, and written, in sequence from and to successive addresses of a non-volatile memory. By reading and writing the data linearly, errors, such as bit errors, present in the non-volatile memory 112 are similar to tape errors. As such, these errors may be handled by existing error managing tape mechanisms. These mechanisms may include, but are not limited to, erasure detection, multi-level error correction codes, and interleaving. Furthermore, by writing the data linearly or sequentially, the NVM locations are accessed in sequence and each location sees the same amount of accesses. As such, the use of the non-volatile memory is relatively benign which results in a lower degradation rate on the cartridge 110. Also due to the sequential nature of the data writing, “wear leveling” and “logical to physical mapping”, processes usually present in non-volatile solid-state memory flash storage controllers are not needed. In addition, the decreased wear and resulting lower degradation rate allow the non-volatile memory 112 used to be an inexpensive memory, decreasing the cost of the cartridge 110 and, ultimately, the cost of the entire storage system.

In embodiments, the NVM drive 102 may be configured to write data to the non-volatile memory 112 without reformatting the data from the tape format. For example, the NVM drive 102 may write data to the non-volatile memory 112 in a raw tape format. For example, the NVM drive 102 may write data to the non-volatile memory 112 in a linear tape-open (LTO) format. By writing the data in an existing and proven tape format, the powerful error correction and sparing capabilities of the format turn non-volatile memory that would be considered poor “media” into high reliability serial storage. In addition, no additional parity chips are required as the/data from the standard tape format, fewer steps are needed to handle the data, resulting in less time to process the data and fewer opportunities for data errors.

It is to be understood that the NVM drive 102 may include any number of additional components not shown in FIG. 2. In addition, any number of the components shown in FIG. 2 may not be included within the NVM drive 102, depending on the specific application.

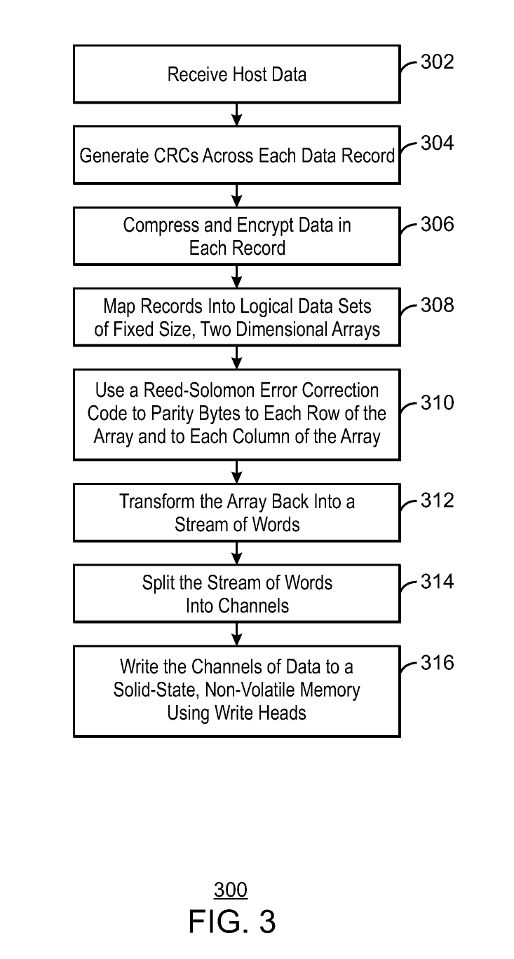

FIG. 3 is a process flow diagram showing an example of a method for writing data to a solid-state, non-volatile memory. At step 302, data is received from the host computer or network. The data may arrive in records, each of which comprises a sequence of bytes or the data may be sliced into records of a desired length after arrival in a NVM drive. At step 304, CRCs or signatures are generated across each record. At step 306, the data in each record is compressed and encrypted. At step 308, the records, and the metadata describing them, are mapped into logical data sets of fixed size. The bytes of each logical data set are also arranged into a two dimensional array. At step 310, a Reed-Solomon error correction code (“C1” ECC) is used to add parity bytes to each row of the array. A second Reed-Solomon error correction code (“C2” ECC) is used to add parity bytes to each column of the array. At step 312, the array of bytes is transformed back into a stream of words in such a way that the bytes covered by each ECC codeword are widely separated, otherwise known as interleaving. At step 314, the stream of words is split into streams or channels in such a way that successive words end up on different channels. The stream of words may be split into any number of channels. For example, the stream of words may be split into 10 channels. In another example, the stream of words may be split into 16 channels. In a further example, the stream of words may be split into 32 channels. After the words are split into channels, in parallel, each of the streams is split into equally sized blocks and a header with an incrementing identity number is added to each block. In an example, the 32 bit words of each block may each be replaced by 33 bit codewords and the codewords output one bit at a time. After the data is formatted, external write amplifiers drive write heads with the bit streams generated by the NVM drive. The number of drive heads may correspond to the number of channels. At step 316, the write heads write the bit streams to a memory, such as a solid-state, non-volatile memory. In particular, the write heads write the bit streams serially in successive memory addresses of the solid-state, non-volatile memory.

At the same time that writing occurs, the written data may be assessed for quality of writing. In an example, a “read-after-write” (RAW) may take place. In such an example, writing may be stopped after each write operation in order for the data to be read back and the quality assessed before the next block of data is written. In another example, a “read-while-write” (RWW) may take place in which the newly written data is read back and assessed while the next block of data is being written. Separate heads read back the freshly written bit streams. The “unformatting” half of the NVM drive verifies in real time whether or not the observed errors are few enough in number that they can be corrected by the C1,C2 parity schemes with sufficient margin to allow for future degradation. If the quality of the RAW/RWW data is deemed to be too low then it is written to memory again. In this way, damaged parts of the memory are effectively “spared out”.

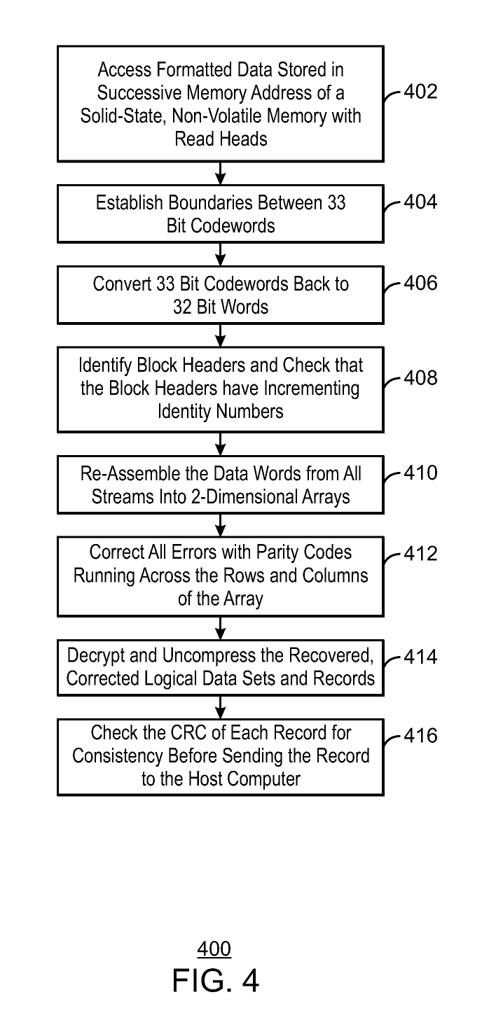

FIG. 4 is a process flow diagram showing a method for data recovery. At step 402, read heads access formatted data stored in successive memory addresses of a solid-state, non-volatile memory. Because the solid-state, non-volatile memory's read circuits will have determined the bit values, it is not necessary for analogue waveforms from the read heads to be sampled at high resolution. It is similarly not necessary for Digital Signal Processing (DSP) to eliminate the inter-symbol interference (ISI) in the waveform and use clock recovery to generate a bit stream from each head, as the solid-state, non-volatile memory's read circuits generally will not suffer from ISI. At step 404, boundaries are established between 33 bit codewords. At step 406, if 33 bit codewords are present, the 33 bit codewords may be converted back to 32 bit words. “Illegal” 33 bit codewords that have arisen may be marked as erasures. At step 408, block headers are identified and checked to have incrementing identity numbers. At step 410, the data words from all streams are re-assembled into two dimensional arrays. At step 412, errors or erasures in the arrays are corrected by means of the C1, C2 parity codes running across the arrays' rows and columns. At step 414, the recovered, corrected logical data sets and records are decrypted and uncompressed. At step 416, the CRC of each record is checked to be consistent with the record's data before the record is sent back to the host computer.

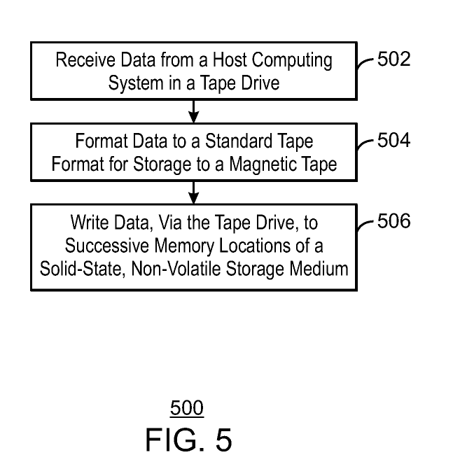

FIG. 5 is a process flow diagram showing a method for writing standard tape format to non-volatile memory. At step 302, data may be received from a host computing system, such as computer 104, network 106, or a combination of 104 and 106, in a NVM drive. For example, data may be received in a buffer included in the NVM drive. At step 304, the data may be formatted to a standard tape format for storage to a magnetic tape, such as an LTO format. An example of formatting the data is described above.

At step 306, the data may be written to successive memory locations of a solid-state, non-volatile storage medium by the NVM drive. The solid-state, non-volatile storage medium may be disposed within the NVM drive, such as within a cartridge inserted in the NVM drive. An example of a cartridge is described above. At least one write element may write the data to the non-volatile memory. For example, multiple write elements may write the data to the non-volatile memory. In an example, sixteen write elements write the data to the non-volatile memory. The write elements may write the data to the non-volatile memory in streams, such as data streams. The data streams may be formed during the formatting process. The write elements may work in parallel to each other, transferring multiple bit streams simultaneously. For example, sixteen write elements may transfer sixteen data streams to sixteen non-volatile memories simultaneously. Each write head may be associated with a particular non-volatile memory. This association of non-volatile memories with write elements may result in improved data transfer rates. The data streams may be written to the non-volatile memory in a sequential or linear way, resulting in a benign use of the memory. Accordingly, inexpensive non-volatile memory, which would typically be considered inferior and of poor quality, may be used. Data may also be linearly read from the non-volatile memory in streams.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method, comprising:
receiving data from a host computing system in a non-volatile memory storage (NVM) drive;
formatting, via the NVM drive, the data for storage to a magnetic tape; and
writing the formatted data to successive memory addresses of a solid-state, random access, non-volatile storage medium.

2. The method of claim 1, wherein writing the formatted data comprises writing to the storage medium via a plurality of channels in parallel.

3. The method of claim 1, wherein each of the plurality of channels is associated with a separate solid-state non-volatile memory device of the storage medium.

4. The method of claim 1, wherein the solid-state non-volatile memory is disposed in a cartridge configured to be compatible with the NVM drive.

5. A system, comprising:
a host computing system configured to send data to and receive data from a non-volatile memory storage (NVM) drive;
a non-volatile memory storage (NVM) drive, comprising data read and write elements; and
a solid-state, random access, non-volatile storage medium disposed within the NVM drive, wherein the NVM drive is configured to write data to and read data from the solid state, random-access, non-volatile storage medium, and wherein the data is formatted for storage to a magnetic tape.

6. The system of claim 5, wherein the solid-state, non-volatile storage medium is disposed within a cartridge.

7. The system of claim 5, wherein the solid-state, non-volatile storage medium is NAND flash memory.

8. The system of claim 5, wherein the NVM drive is configured to write the data to the solid-state, non-volatile storage medium linearly.

9. The system of claim 5, wherein the NVM drive is configured to write the data to the solid-state, non-volatile storage medium in a standard magnetic tape format.

10. The system of claim 5, wherein the NVM drive comprises multiple data channels and the data channels read or write to the solid-state, non-volatile storage medium in parallel.

11. The system of claim 5, wherein a separate solid-state, non-volatile storage medium device is associated with each channel.

12. The system of claim 11, wherein each separate solid-state, non-volatile storage medium device is coupled to a separate dedicated memory controller associated with a corresponding channel.

13. A cartridge, comprising:
a solid-state, random access, non-volatile storage medium, wherein the cartridge is configured to be receive, from a non-volatile memory (NVM) storage drive, data formatted for storage to magnetic tape.

14. The cartridge of claim 13, wherein the cartridge comprises multiple solid-state, non-volatile storage media.

15. The cartridge of claim 14, wherein the number of solid state, non-volatile storage media within the cartridge corresponds directly to a number of channels within the NVM drive.
